(19) United States
(12) Patent Application Publication
(10) Pub. No.: US 2012/0133686 A1
(43) Pub. Date: May 31, 2012

(54) BACKLIGHT DEVICE WITH LIGHT EMITTING DEVICES IN AN ALTERNATING ARRANGEMENT

(75) Inventor: Takeshi ADACHI, Saitama (JP)

(73) Assignees: ATRC CORPORATION, Saitama (JP); MITSUMI ELECTRIC CO., LTD., Tokyo (JP)

(21) Appl. No.: 13/304,456

(22) Filed: Nov. 25, 2011

(30) Foreign Application Priority Data
Nov. 30, 2010 (JP) 2010-267418

(51) Int. Cl. G09G 5/10

(52) U.S. Cl. 345/690

(57) ABSTRACT

A backlight device includes a plurality of light emitting devices arranged at predetermined positions to act as backlight for a display screen, and a plurality of drive circuits that supply currents to the plurality of light emitting devices, wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit, and wherein the plurality of light emitting devices are spatially placed in an alternating arrangement of one or more of the first light emitting devices and one or more of the second light emitting devices.

### BACKGROUND OF THE INVENTION

1. Field of the Invention

The disclosures herein generally relate to a backlight device, a display apparatus having such a backlight device, and a lighting apparatus, and particularly relate to a backlight device, a display apparatus having such a backlight device, and a lighting apparatus for which uneven luminance in backlighting or lighting is prevented.

2. Description of the Related Art

In respect of various types of display apparatuses for displaying video and images, there have been ongoing studies to achieve improved image quality and reduced power consumption. LCDs (liquid crystal displays) are becoming more prevalently used as display apparatuses.

In general, an LCD includes an output panel for displaying images by use of light, and a backlight unit for generating the light. The backlight unit is designed with a main focus on its capability to provide uniform light distribution in the effective display area of an output panel in which images are displayed. LED (light emitting diode) backlight units are becoming of particular interest in this regard. LEDs are also used as lighting apparatuses.

A backlight unit or lighting apparatus using LEDs may have an array of white color LEDs to emit white light, or may have an array of LEDs corresponding to three respective colors, i.e., R (red), G (green), and B (blue) to produce white light by combining three colors. The above-noted white color LEDs may include one that produces a white color by combining a short-wavelength LED with a fluorescent body, one that produces a white color by combining a blue-color LED with a fluorescent body, and one that produces a white color by combining a blue-color LED with a yellow-color fluorescent body.

In conventional backlight devices, drive circuits (e.g. driver ICs) or the like are used to turn on and off a plurality of arranged LEDs at constant intervals, thereby minimizing voltage loss and current loss in the LEDs.

The above-noted backlight device will be described in the following. FIGS. 1A and 13 are drawings illustrating examples of a related-art backlight device. A backlight device 10 illustrated in FIGS. 1A and 1B includes an LCD panel 11 serving as a display unit, LEDs 12, and driver ICs 13. In this specification, a reference number n may be used to collectively refer to n-1, n-2, and so on. For example, the LEDs 12 may be used to collectively refer to LEDs 12-1 and LEDs 12-2 illustrated in FIG. 1A. In FIG. 1A, the LEDs 12-1 and the LEDs 12-2 are connected in series, respectively, and are placed at the upper end and the lower end, respectively, of the LCD panel 11. The LEDs 12-1 and 12-2 are driven by electric currents supplied from the driver ICs 13-1 and 13-2, respectively, which are provided separately for the respective LED sets.

Specifically, the driver ICs 13-1 and 13-2 illustrated in FIG. 1A supply electric currents i₁ and i₂ to drive the LEDs 12-1 and 12-2, respectively, thereby turning on the LEDs 12 as a backlight unit. In the example illustrated in FIG. 1A, the LED 12-1 provides backlight for an area A of the LCD panel 11, and the LED 12-2 provides backlight for an area B of the LCD panel 11.

The control of backlight as illustrated in FIG. 1A is not limited to this particular example. For example, four driver ICs 13-1 through 13-4 may be, provided as illustrated in FIG. 1B to separately drive LEDs 12-1 through 12-4, respectively, thereby providing backlighting at predetermined locations of the LCD panel 11 (i.e., areas A through illustrated in FIG. 1B).

However, in the configuration that uses simple wire connections as illustrated in FIGS. 1A and 1B, driver-IC-and-LED sets, each of which is comprised of a driver IC and an array of LEDs, are simply provided side by side. Electric currents i₁ through i₄ supplied from the respective driver ICs 13-1 through 13-4 may have different current amounts from each other due to IC variations, which results in uneven luminance in the areas A through D of the LCD panel 11.

Systems for preventing such uneven luminance are disclosed in Patent Documents 1 through 3, for example. Patent Document 1 discloses a backlight device provided with an LED drive and control unit that drives and controls a plurality of light emitting diodes arranged in a predetermined array direction by using a PWM (i.e., pulse width modulation) light adjustment. Two light emitting diodes adjacent to each other in the array direction are driven to turn on such that the respective on-and-off phases of PWM light adjustment are displaced from each other with respect to these two adjacent diodes.

Patent Document 2 discloses a backlight device that illuminates an object from the back side thereof with light emitted from LEDs. The backlight device includes an LED backlight unit in which LED units each having a plurality of LEDs connected in parallel are provided, and a current control unit that supplies constant currents to the respective LED units. The LEDs are arranged such that a straight line connecting the LEDs connected in parallel to constitute the LED units has at least a bending point.

Patent Document 3 discloses a lighting apparatus provided with a light source that includes a light guide plate and a plurality of light emitting devices capable of emitting light at different luminance levels, the light emitting devices being placed at opposite side edges of the light guide plate and arranged along the edge lines of the light guide plate. Those of the light emitting devices which have the same luminance level are connected in series.

In the technologies disclosed in these patent documents, a plurality of driver ICs may be simply arranged as illustrated in FIGS. 1A and 1B, so that LED currents vary from one another due to current variations caused by the product variations of the driver ICs. Uneven luminance can thus be not fully removed.

Accordingly, it may be desirable to provide a backlight device, a display apparatus having such a backlight device, and a lighting apparatus for which uneven luminance in backlighting or lighting is prevented by supplying stable, uniform currents.
[Patent Document 1] Japanese Patent Application Publication No. 2008-198430
[Patent Document 2] Japanese Patent Application Publication No. 2007-109691
[Patent Document 3] Japanese Patent Application Publication No. 2006-127798

### SUMMARY OF THE INVENTION

According to one embodiment, a backlight device includes a plurality of light emitting devices arranged at predetermined positions to act as backlight for a display screen, and a plurality of drive circuits that supply currents to the plurality of light emitting devices, wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit, and wherein the plurality of light emitting devices are spatially placed in an alternating arrangement of one or more of the first light emitting devices and one or more of the second light emitting devices.

According to one embodiment, a display apparatus includes a display unit, a plurality of light emitting devices arranged at predetermined positions to act as backlight for a display screen of the display unit, and a plurality of drive circuits that supply currents to the plurality of light emitting devices, wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit, wherein the plurality of light emitting devices are spatially placed in an alternating arrangement of one or more of the first light emitting devices and one or more of the second light emitting devices, and luminance of the plurality of light emitting devices is corrected in response to video images displayed by the display unit.

According to one embodiment, a lighting apparatus includes a plurality of light emitting devices, and a plurality of drive circuits that supply currents to the plurality of light emitting devices, wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit, and wherein the plurality of light emitting devices are spatially placed in an alternating arrangement of one or more of the first light emitting devices and one or more of the second light emitting devices.

According to at least one embodiment of the disclosures herein, uneven luminance in backlighting or lighting is prevented by supplying stable, uniform currents.

### BRIEF DESCRIPTION OF THE DRAWINGS

Other objects and further features of the present invention will be apparent from the following detailed description when read in conjunction with the accompanying drawings, in which:

FIGS. 1A and 1B are drawings illustrating examples of a related-art backlight device;

FIG. 2 is a drawing illustrating a first embodiment of the backlight device;

FIG. 3 is a drawing illustrating a second embodiment of the backlight device;

FIGS. 4A through 4E are drawings illustrating examples of backlight LED arrangements;

FIGS. 5A and 5B are drawings illustrating examples of block information;

FIG. 6 is a drawing illustrating an example of the functional configuration of a display device having the backlight device according to the embodiments; and

FIGS. 7A and 7B are drawings illustrating examples of other applications of the backlight device according to the embodiments.

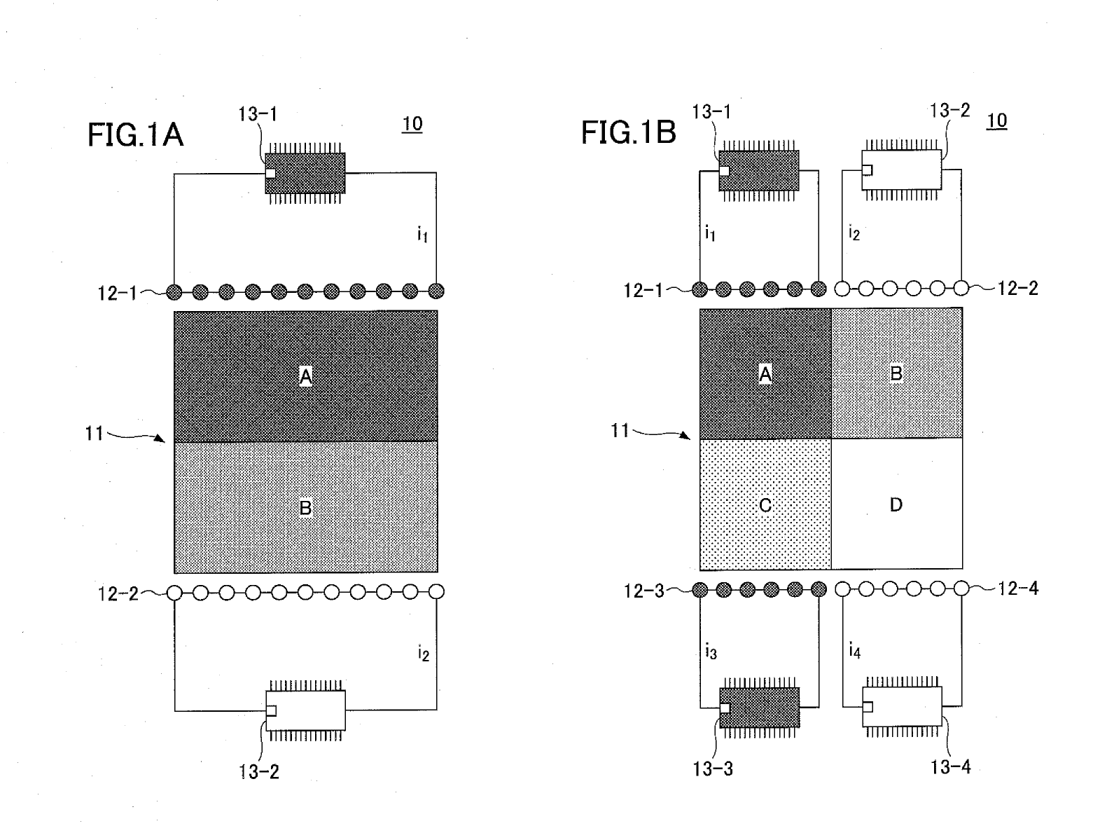

### DESCRIPTION OF THE PREFERRED EMBODIMENTS

Embodiments of the technology disclosed herein utilize alternating wire connections (i.e., cross wire connections) reducing the likelihood of uneven luminance rather than using simple wire connections as the wire connections used for backlighting or lighting. This arrangement serves to spatially distribute luminance variation of the light emitting devices (e.g., LEDs), thereby reducing uneven luminance over the entire panel. The embodiments of the technology disclosed herein utilize alternating wire connections to spatially distribute electric currents supplied from drive and control units (e.g., driver ICs) to light emitting devices to drive the light emitting devices, thereby evenly distribute luminance distribution over the entire panel. Further, the embodiments of the technologies disclosed herein may achieve any alternating wire connections to absorb luminance variation according to the number of driver ICs, device blocks each having a plurality of light emitting devices, etc.

In the following, embodiments of a backlight device having the features as described above, a display apparatus having such a backlight device, and a lighting apparatus will be described with reference to the accompanying drawings. In the embodiments described below, LEDs are used as light emitting devices, and an LCD is used as an example of a display unit. Such a configuration is intended to be a non-limiting example. The embodiments described below are mainly directed to luminance control that is performed at the time of outputting video signals to a display unit. Such a configuration is intended to be a non-limiting example, and the disclosed embodiments may as well be applied to the displaying of images in general.

<Example of Schematic Configuration of Backlight Device>

In the following, an example of the schematic configuration of a backlight device will be described.

### First Embodiment

### Top and Bottom Alternating Wire Connections

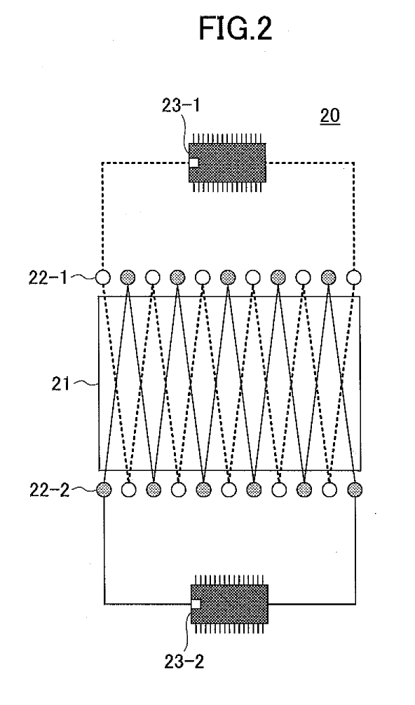

FIG. 2 is a drawing illustrating a first embodiment of the backlight device. A backlight device 20 illustrated in FIG. 2 includes an LCD panel 21 serving as a display unit, LEDs 22-1 and 22-2 serving as light emitting devices, and driver ICs 23-1 and 23-2 serving as drive and control units. FIG. 2 illustrates an example of top and bottom alternating wire connections.

In the backlight device 20, the driver ICs 23 and LEDs 22 are connected through alternating wire connections. Specifically, the LEDs 22-1 and 22-2 are the LEDs having the same color, and are connected to the respective driver ICs as illustrated in FIG. 2. The LEDs connected to the same driver IC 23 are connected in series, and are placed alternately at the top and the bottom of the LCD panel 21 as the backlight-purpose LEDs for the LCD panel 21.

In the manner as described above, the plurality of drive circuits include the driver IC 23-1 serving as a first drive circuit and the driver IC 23-2 serving as a second drive circuit, and the plurality of light emitting devices include the LEDs 22-1 serving as a plurality of first light emitting devices and the LEDs 22-2 serving as a plurality of second light emitting devices. The plurality of first light emitting devices 22-1 are connected in series to the first drive circuit 23-1, and the plurality of second light emitting devices 22-2 are connected in series to the first drive circuit 23-2. The plurality of light emitting devices are spatially placed in an alternating arrangement of one or more of the plurality of first light emitting devices 22-1 and one or more of the plurality of second light emitting devices 22-2.

In the example illustrated in FIG. 2, alternating of LEDs occurs in such a manner that every other LED belongs to the same group. This configuration is intended to be a non-limiting example. For example, every predetermined number of LEDs, such as every two LEDs or every three LEDs, may be placed alternately at the top and at the bottom and connected in series. Namely, an alternating arrangement of two or three of the plurality of first light emitting devices 22-1 and two or three of the plurality of second light emitting devices 22-2 may be provided. Further, a third drive circuit may be provided, and a plurality of third light emitting devices may be connected in series to the third drive circuit. In this case, the plurality of light emitting devices are spatially placed in an alternating arrangement (or sequential arrangement) of one or more of the plurality of first light emitting devices, one or more of the plurality of second light emitting devices, and one or more of the plurality of third light emitting devices. When focus is placed on the plurality of first light emitting devices and the plurality of second light emitting devices, an alternating arrangement of one or more of the plurality of first light emitting devices and one or more of the plurality of second light emitting devices is in existence, despite the fact that the plurality of third light emitting devices are placed therebetween. Similarly, a fourth drive circuit and a plurality of fourth light emitting devices may be provided. In this manner, the number of drive circuits and the number of sets of light emitting devices are not limited to two or three.

### Second Embodiment

### Adjacent Alternating Wire Connections

The wire connections of LEDs in the above-described first embodiment can reduce uneven luminance. Since the LEDs are arranged alternately at the top and the bottom as illustrated in FIG. 2, however, the connecting wires ends up being laid out back and forth on the back face of the LCD panel. This may result in an increase of wiring cost. In the following, a description will be given of a second embodiment that is made in light of the above-noted issues.

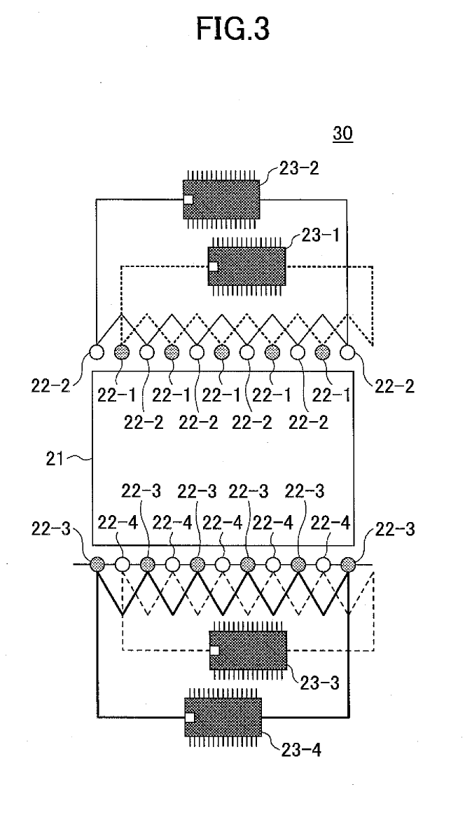

FIG. 3 is a drawing illustrating a second embodiment of the backlight device. A backlight device 30 illustrated in FIG. 3 includes an LCD panel 21, LEDs 22-1 through 22-4, and driver ICs 23-1 through 23-4. FIG. 3 illustrates an example of adjacent alternating wire connections.

In the backlight device 30 illustrated in FIG. 3, alternating wire connections are utilized for the LEDs placed at the top and the LEDs placed at the bottom, respectively, of the LCD panel 21 illustrated in FIG. 3, by using a plurality of driver ICs for the top LEDs and the bottom LEDs, respectively.

In the second embodiment, the driver ICs 23-1 and 23-2 are situated at the top of the LCD panel 21, and the driver ICs 23-3 and 23-4 are situated at the bottom of the LCD panel 21.

The driver ICs 23-1 and 23-2 are connected to the LEDs 22-1 and 22-2, respectively, which are both situated at the top of the LCD panel 21. The LEDs 22-1 and the LEDs 22-2 are placed in an alternating arrangement at the top of the LCD panel 21.

The LEDs 22-1 are of the same color, and the LEDs 22-2 are also of the same color. This arrangement can thus minimize errors attributable to differences in the characteristics of connected LEDs, thereby preventing uneven luminance.

Similarly, the driver ICs 23-3 and 23-4 are connected to the LEDs 22-3 and 22-4, respectively, which are both situated at the bottom of the LCD panel 21. The LEDs 22-3 and the LEDs 22-4 are placed in an alternating arrangement at the bottom of the LCD panel 21.

The LEDs 22-3 are of the same color, and the LEDs 22-4 are also of the same color. This arrangement can thus minimize errors attributable to differences in the characteristics of connected LEDs, thereby preventing uneven luminance.

In the second embodiment, LEDs connected to different wires alternate with each other. Such alternating may not have to occur for each LED. As in the first embodiment, alternating may occur once in every predetermined number of LEDs such as every two LEDs or every three LEDs, for example.

In place of the top and bottom alternating wire connections and the adjacent alternating wire connections described above, alternating wire connections utilizing a predetermined arrangement pattern may be used for which a random arrangement method is used to randomly arrange LEDs. For example, the top and bottom alternating wire connections or the adjacent alternating wire connections may be used in a predetermined area inclusive of the center of the LCD panel 21 at which users pay the most visual attention. A conventional series wire connection may be used in other areas (e.g., peripheral areas). Alternatively, the top and bottom alternating wire connections and the adjacent alternating wire connections may also be used in combination in these other areas according to the size and shape of the LCD panel in order to reduce wiring cost.

<Configuration of LEDs>

As previously described, an LED backlight unit may have an array of white color LEDs to emit white light, or may have an array of LEDs corresponding to three respective colors, i.e., R (red), G (green), and B (blue) to produce white light by combining three colors.

Accordingly, the three LEDs are arranged alternately in the first embodiment and the second embodiment described above when utilizing LEDs of the three colors R (red), G (green), and B (blue). In the example illustrated in FIG. 3, for example, three driver ICs for the respective colors R, G, and B may be provided at the top and at the bottom, respectively, and a plurality of LEDs may be connected to these driver ICs.

In these embodiments, it may be preferable to arrange one or more adjacent LEDs in accordance with variation information or color differences that are preset for the LEDs on a color-specific basis. Specifically, luminance control may be performed by providing wire connections which result in an alternating arrangement of the highest luminance classification and the lowest luminance classification according to variation information that is set for each LED. Alternatively, luminance control may be performed by connecting LEDs with wire connections which result in an alternating arrangement of different colors such as R, G, and B.

Variation information for LEDs may include stationary variation, temperature variation, aging variation, etc. Stationary variation refers to product variation appearing at the component level, and has a known approximate range on a color-specific basis. Temperature variation refers to variation that occurs with a change in ambient temperature. Aging variation refers to variation that occurs with the passage of time.

In the embodiments described above, electric currents supplied from driver ICs to LEDs through alternating wire connections may be spatially distributed according to variation information described above, thereby evenly distribute luminance variation over the entire panel. The alternating wire arrangements in these embodiments may preferably adjusted such that more than a predetermined number of LEDs having the same variation information are not arranged in a row if LEDs have different variation information despite the same color. This may also be the case for LEDs having different colors.

The number of LEDs connected to the same connection line is not limited to the example used in these embodiments. The number of LEDs may be changed according to the characteristics of the LCD panel 21 and the backlight LEDs 22, the size and shape of the LCD panel 21, or the detail of backlight control. For example, LEDs having the same color may not have to be driven by a single driver IC. A plurality of driver ICs may be used, and each of these may be connected for the control purpose to a predetermined number of LEDs having the same color.

<High Tolerance Voltage Driver IC>

In the embodiments described above, high-tolerance-voltage driver ICs may be used to reduce the number of driver ICs and to simplify the layout of connecting wires. In the case of driving and controlling (e.g., turning on and off) LEDs by connecting the LEDs in series as backlight for the LCD panel 21, the use of a low-tolerance-voltage IC makes it possible to control only a small number of LEDs, resulting in a large number of driver ICs being needed for the purpose of driving and controlling LEDs used as backlight for the LCD panel 21. Further, the use of plural driver ICs ends up creating variation in electric currents flowing through the LEDs due to variation between the ICs, which results uneven luminance. Factors that create variation may increase with changes attributable to the passage of time and temperature drift, thereby further increasing the unevenness of luminance.

In the embodiments described above, therefore, a small number of high-tolerance-voltage driver ICs may be used to supply stable, constant electric currents to the LEDs. In general, the number of LEDs driven by a driver IC is determined by the tolerance voltage of the driver IC. The tolerance voltage of a single LED is about 3 V. The use of 10 series-connected LEDs thus requires a driver IC having a tolerance voltage of about 30 V, and the use of 20 series-connected LEDs requires a driver IC having a tolerance voltage of about 60 V. In the embodiments described above, it may be preferable to use a high-tolerance-voltage driver IC having a tolerance voltage of about 150 V for use with 50 series-connected LEDs or having a tolerance voltage of about 300 V for use with 100 series-connected LEDs. The tolerance voltage is not limited to these examples.

According to the embodiments described above, a plurality of LEDs and driver ICs for driving these LEDs are connected in such a manner that adjacent LEDs are not connected to each other. In order to avoid inherent luminance interference, the LED drivers and the LEDs are connected in an alternating arrangement, thereby supplying stable, constant currents to the backlight unit to prevent uneven luminance in backlighting. In these embodiments, moreover, electric currents supplied from the driver ICs to the LEDs may be spatially distributed through alternating wire connections, thereby evenly distribute luminance variation over the entire panel.

In these embodiments, further, the use of alternating wire connections makes it possible to reduce uneven luminance efficiently with the use of a smaller number of driver ICs. In these embodiments, also, high-tolerance-voltage driver ICs are used to collectively control the LEDs, thereby supplying stable, constant electric currents to the LEDs to further reduce uneven luminance.

In the embodiments described above, the LEDs are arranged at the top and the bottom of the LCD panel 21. This is not a limiting example. Backlighting LEDs may be provided at the left-hand side and the right-hand side of the LCD panel 21 or over the entire back surface of the LCD panel 21.

<Example of Backlight LED Arrangement>

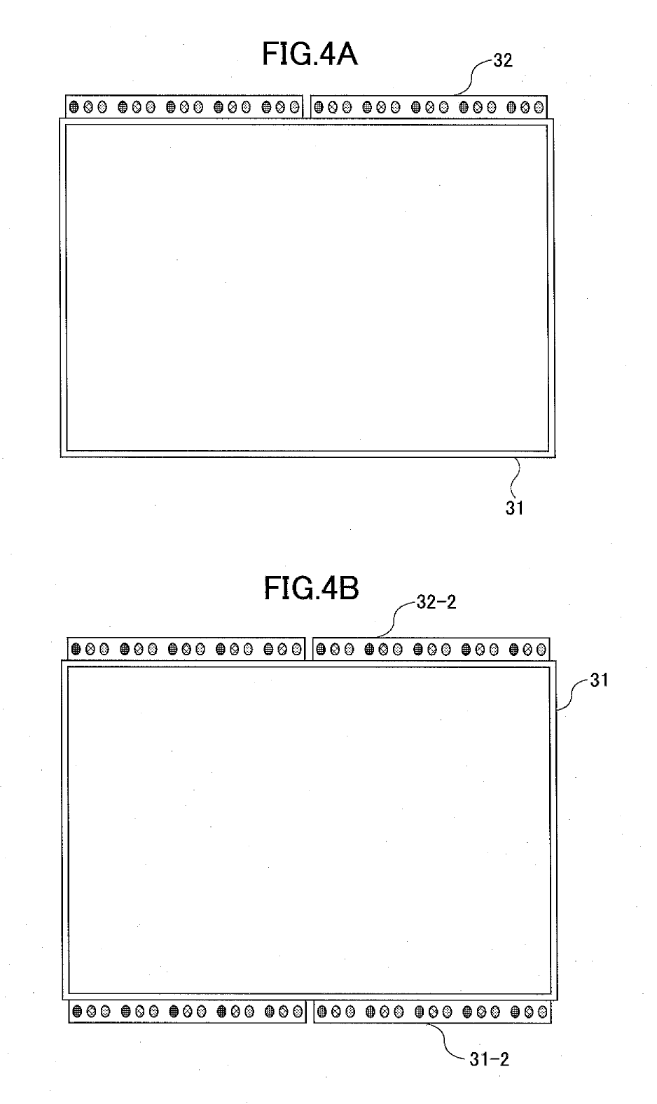

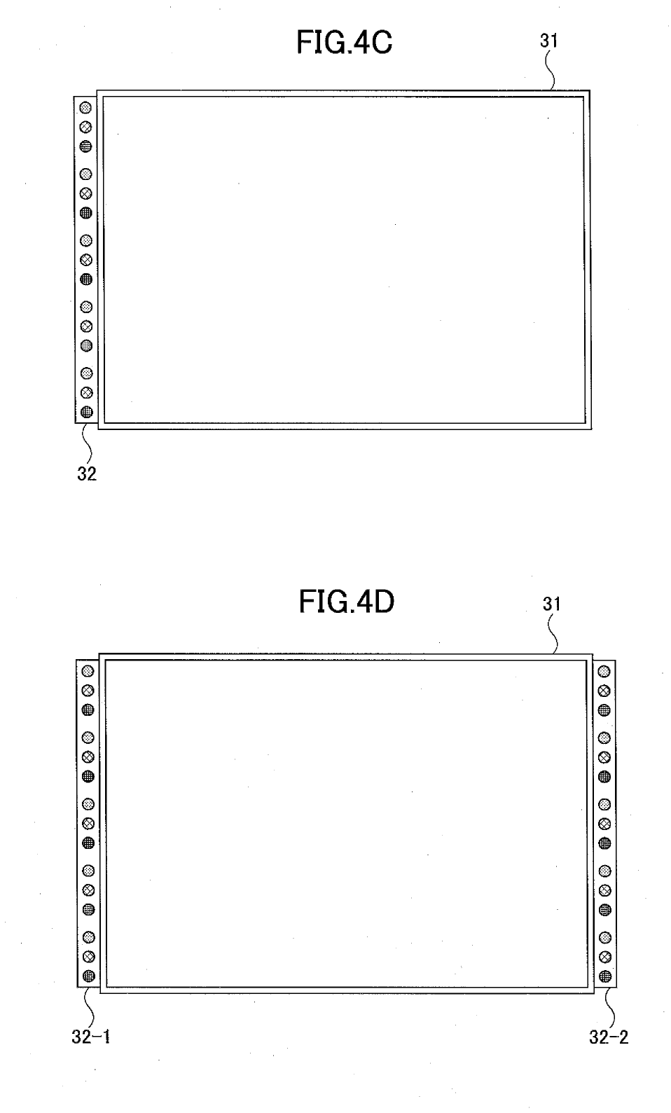

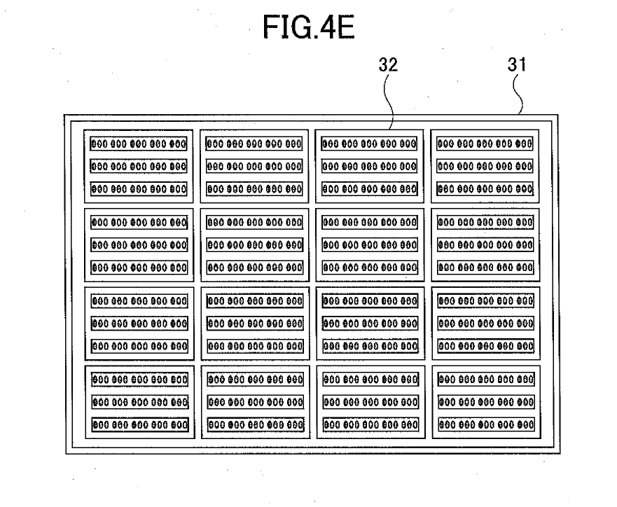

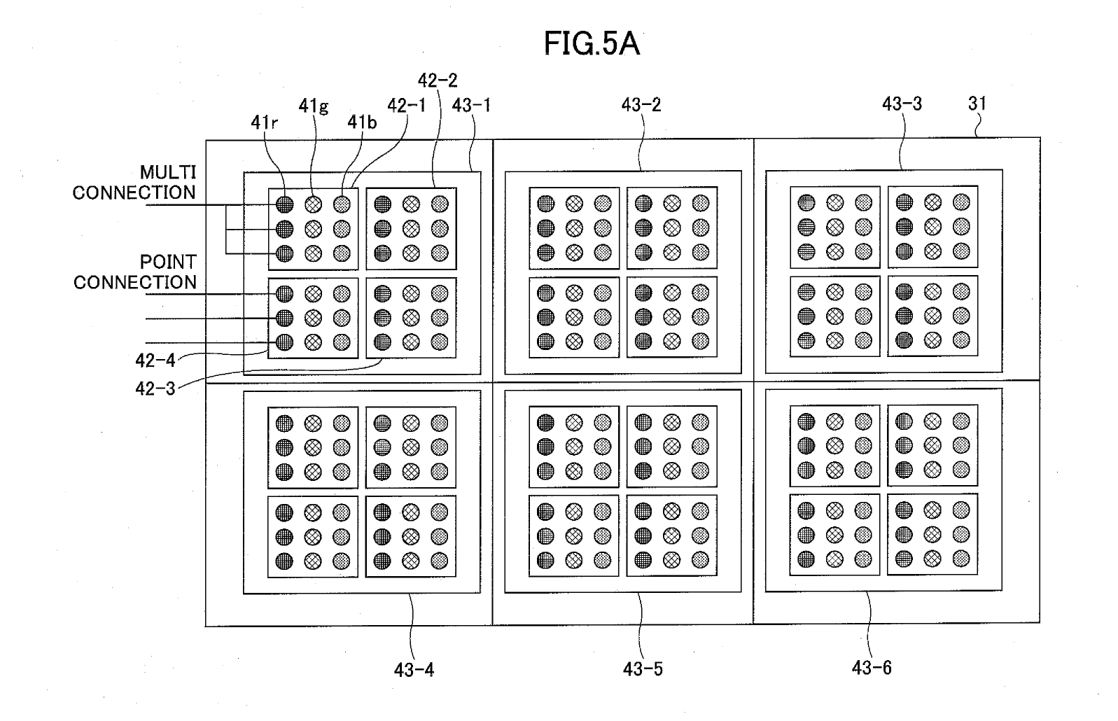

In the following, examples of backlight LED arrangements will be described with reference to drawings. FIGS. 4A through 4E are drawings illustrating examples of backlight LED arrangements.

As illustrated in FIGS. 4A through 4E, an LCD panel 31 serving as a display unit has one or more device blocks 32 situated at predetermined positions. The one or more device blocks 32 include the LEDs as described above situated at predetermined positions. The LEDs illustrated in FIGS. 4A through 4E are connected through wires described in the disclosed embodiments such as the first embodiment and the second embodiment described above.

Specifically, the device block 32 may be disposed at the top of the LCD panel 31 (FIG. 4A). Alternatively, the device blocks 32-1 and 32-2 may be disposed at the top and the bottom of the LCD panel 31 (FIG. 4B). Further, as in the other embodiments, the device block 32 may be situated at either one of the left-hand side and the right-hand side of the LCD panel 31 (e.g., at the left-hand side in the case of FIG. 4C), and the device blocks 32-1 and 32-2 may be situated on both the left-hand side and the right-hand side (FIG. 4D). Moreover, a predetermined number of device blocks 32 may be disposed over the entire back surface of the LCD panel 31 as described above (FIG. 4E).

The examples of backlight LED arrangements described above are not intended to be limiting. The device blocks may be disposed at all of the top, the bottom, the left-hand side, and the right-hand side, or may be disposed in the manner that combines two or more of the above-noted examples. The device blocks 32 described above may be divided as blocks having a predetermined size based on at least one of the detection results that include an APL (i.e., average picture level), a luminance histogram, a color histogram, and a frequency histogram, which are obtained from input video signals. This is not a limiting example, and division may be performed to produce preset blocks.

In the embodiments described above, at least one of the LEDs connected in series in a device block 32 may fail to be turned on due to aging and wearing. In anticipation of such an event, bypass drive control may be performed upon detecting the presence of a failed LED, thereby avoiding affecting the remaining LEDs.

<Block Information>

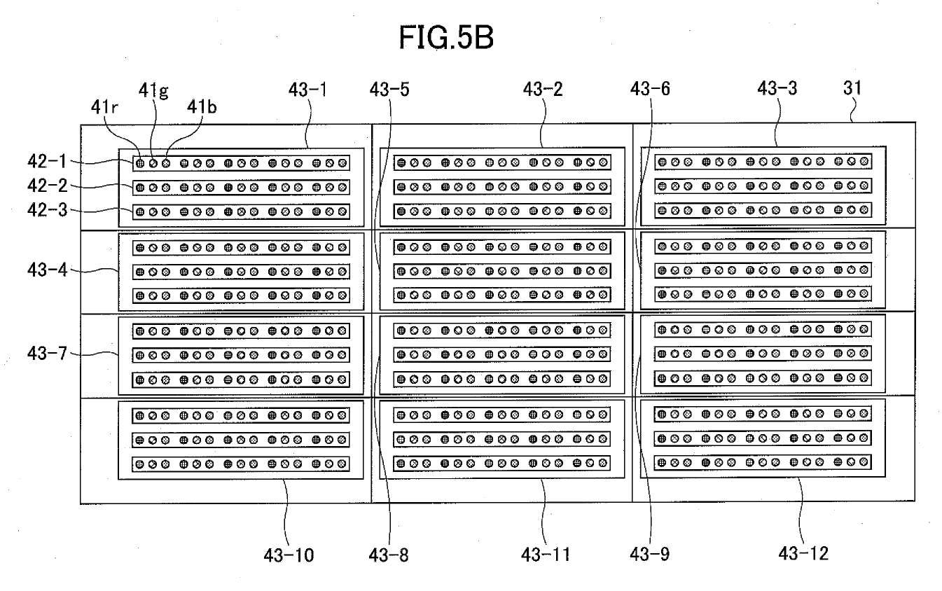

In the following, information about device blocks in which light emitting devices (e.g., LEDs) are arranged in series will be described with reference to drawings. FIGS. 5A and 5B are drawings illustrating examples of block information. FIGS. 5A and 5B illustrate LEDs used as LCD backlight.

In the examples illustrated in FIGS. 5A and 5B, RGB devices (elements) 41r, 41g, and 41b are provided in a predetermined display screen area. These devices are connected to driver ICs or the like through multi connections or point connections.

In the examples illustrated in FIGS. 5A and 5B, a cell is comprised of devices 41r, 41g, and 41b corresponding to the respective colors. In the examples illustrated in FIGS. 5A and 5B, a device block 42 is comprised of plural cells, and a predetermined number of device blocks 42 are disposed at their respective positions to constitute a luminance block 43 for correcting luminance. The numbers and arrangements of blocks illustrated in FIGS. 5A and 5B are not a limiting example, and may be modified according to the screen size of the LCD panel 31 or the like.

The backlight devices illustrated in FIGS. 5A and 5B have a top type configuration that is designed to be placed on the back face of an LCD panel. This is not a limiting example. For example, an edge type configuration may be used in which blocks are situated at the bottom of the LCD panel 31, at one of the left-hand side and the right-hand side, or at both sides as illustrated in FIGS. 4A through 4E.

In the embodiments described here, wire connections described in connection with the first embodiment and the second embodiment are used. In the case of FIG. 5A, for example, luminance blocks 43-1 through 43-6 are situated at their respective positions on the back face of the LCD panel 31, and each of the luminance blocks 43 includes device blocks 42-1 through 42-4. In this embodiment, a predetermined number of LEDs or the like having the same color may be connected in an alternating arrangement for each of the luminance blocks 43 or for each of the device blocks 42.

Likewise in FIG. 5B, luminance blocks 43-1 through 43-12 are provided as backlight for the LCD panel 31, and each of the luminance blocks 43 includes plural device blocks 42-1 through 42-3. In this configuration, a predetermined number of LEDs for the same color may be connected in an alternating arrangement for each of the luminance blocks or for each of the device blocks.

In the present embodiment, more than a predetermined number of LEDs connected to the same driver IC are prevented from being arranged in a row as adjacent LEDs by using multi connections or point connections utilizing alternating wire connections as described in the first embodiment and the second embodiment, thereby reducing uneven luminance.

<Display Apparatus Having the Backlight Device>

In the following, an example of the configuration of a display apparatus having the backlight device 10 will be described with reference to drawings.

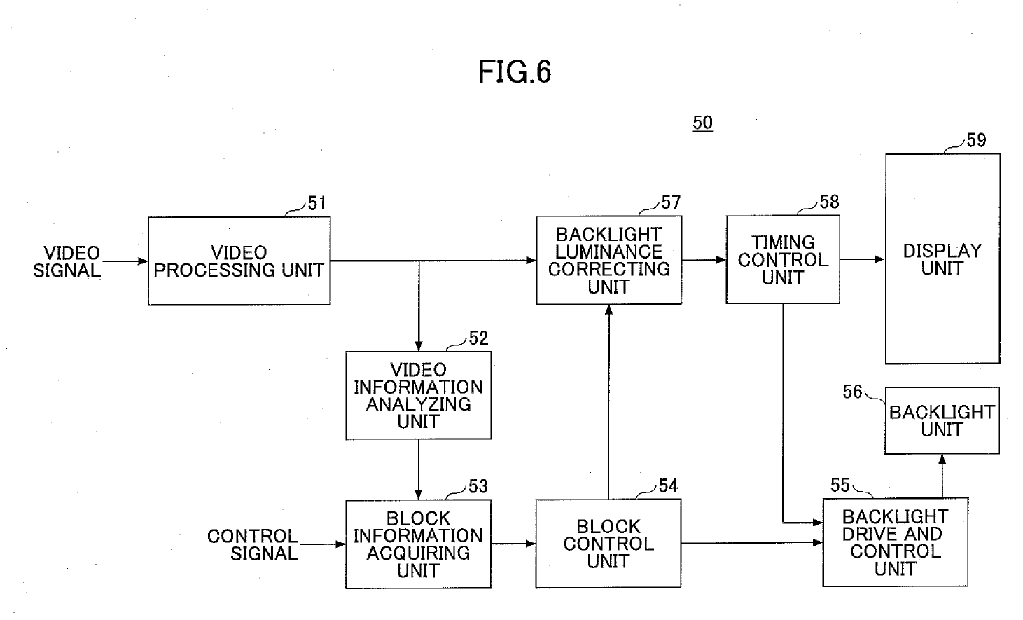

FIG. 6 is a drawing illustrating an example of the functional configuration of a display device having the backlight device according to a present embodiment. A display apparatus 50 illustrated in FIG. 6 includes a video processing unit 51, a video information analyzing unit 52, a block information acquiring unit 53, a block control unit 54, a backlight drive and control unit 55, a backlight unit 56, a backlight luminance correcting unit 57, a timing control unit 58, and a display unit 59. In the present embodiment, the backlight drive and control unit 55 and the backlight unit 56 correspond to the backlight device described above.

The video processing unit 51 decodes signals when input video signals are compressed and coded. Further, the video processing unit 51 performs decoding (descrambling) by use of preset key information or the like when the input video signals are decrypted (e.g., scrambled) as in the case of restricted broadcast reception. Namely, the video processing unit 51 converts the input video signals in such a proper manner as to make it possible for units situated at the subsequent stages to process the video signals and for the display unit 59 to display video images. The video processing unit 51 supplies the signals to the video information analyzing unit 52 and to the backlight luminance correcting unit 57.

The video information analyzing unit 52 extracts at least one of an APL, a luminance histogram, a color histogram (hue, degree of color saturation), and a frequency histogram from the video signals supplied from the video processing unit 51. Afterwards, the video information analyzing unit 52 analyzes the video information based on the detected information. Namely, the video information analyzing unit 52 acquires histogram information, profile information, etc. about the video (images), thereby making it possible for proper backlight luminance control suitable for the input video to be performed based on the acquired information. The video information analyzing unit 52 outputs analyzed results to the block information acquiring unit 53.

Based on the analysis results supplied from the video information analyzing unit 52 and preset control signals regarding the video signals, the block information acquiring unit 53 selects a unit size of a block (e.g., in units of pixels or in units of inches). In this manner, the block unit size is determined based on the video information, thereby providing for backlight control to be performed on a block-specific basis in accordance with the video information.

When division by a predetermined block unit is performed in the present embodiment, the resulting block may be a square block such as a block having a size of one pixel by one pixel, 2 pixels by 2 pixels, 4 pixels by 4 pixels, or 16 pixels by 16 pixels. However, this is not a limiting example.

Processing by the block information acquiring unit 53 may be performed at the timing at which the control signals are supplied from an external source, for example. Alternatively, processing may be performed based on the preset control signals at the timing at which the analysis results are supplied from the video information analyzing unit 52. The block information acquiring unit 53 supplies the obtained block information to the block control unit 54.

The block control unit 54 performs offset control and nonlinear correction on a block-specific basis based on the block information supplied from the block information acquiring unit 53, thereby providing for backlight luminance to be controlled on a block-specific basis according to the video signals. The block control unit 54 also generates control signals by performing pulse modulation such as PWM in accordance with the block-specific luminance control information about the input video signals. The control signals used in the present embodiment may include drive control information comprised of address information and control data in order to perform drive control separately for each of the driver ICs that are connected in series, for example.

The block control unit 54 supplies luminance control information to the backlight drive and control unit 55. The luminance control information is used to control the luminance of predetermined LEDs at predetermined timings through the driver ICs 13. The block control unit 54 supplies the luminance control information to the backlight luminance correcting unit 57. Further, the block control unit 54 supplies the block-specific offset control information and nonlinear correction information to the backlight drive and control unit 55 and to the backlight luminance correcting unit 57.

The backlight drive and control unit 55 drives and controls backlight at each of the block positions in response to the block-specific luminance control information, offset control information, and nonlinear correction information supplied from the block control unit 54, thereby turning on the LEDs of the backlight unit 56 at predetermined timings. The driver ICs may be included in the backlight drive and control unit 55. The backlight drive and control unit 55 supplies the control signals to all the driver ICs that are connected in series. Each driver IC checks the control signals to determine whether the control signals include address information indicative of its own preset address. Upon finding the address information indicative of its own address, the driver IC performs drive control based on the detail of control corresponding to such address information.

The backlight drive and control unit 55 of the present embodiment may supply control signals for driving LEDs through timing control to the backlight unit 56 in response to a clock signal supplied from the timing control unit 58, thereby driving the backlight in synchronization with the video signals supplied to the display unit 59 from the timing control unit 58.

The backlight generally includes LEDs corresponding to devices for three colors R (red), G (green), and B (blue) provided in the LCD. Accordingly, it may be preferable to perform pixel-by-pixel adjustment on a LED-device-specific basis. Such an arrangement, however, requires additional cost and processing time. In the present embodiment, thus, processing is performed on a block-specific basis. This can achieve cost reduction and efficiency.

The backlight drive and control unit 55 supplies the control signals for respective blocks to the backlight unit 56. Based on the drive control signals for respective blocks, the backlight unit 56 performs predetermined luminance control to cause the LEDs situated at predetermined positions in each block to emit light at a predetermined luminance level, which is shone on the screen of the display unit 59 as backlight.

The backlight luminance correcting unit 57 performs luminance correction on the video signals supplied from the video processing unit 51 by use of the drive control information for backlight based on the luminance control information, offset control information, and nonlinear correction information supplied from the block control unit 54. Namely, the backlight luminance correcting unit 57 performs inverse-correction on block-specific dimming control information for trimming purposes for feedback to the video signal system.

Backlight is situated on the back face of the display unit 59, for example, and is driven on a block-specific basis for luminance control purposes. Backlight is driven at low resolution that is lower than the resolution of video signals. According to the present embodiment, block luminance interference that causes a difference from the luminance resolution of video signals can be prevented, thereby making it possible to display optimum video images easy for users to watch on the display screen of the display unit 59. Further, the light emitting devices such as LEDs in the backlight device are connected in an alternating arrangement as described in the first embodiment and the second embodiment. This reduces uneven luminance.

Further, the backlight luminance correcting unit 57 corrects video signals by use of the offset control information and nonlinear correction information, thereby controlling luminance, contrast, and colors in addition to providing the impulse control function for backlighting.

For the backlight luminance correcting unit 57 used in the present embodiment, information for feedback to the video signal system varies depending on the configuration of luminance blocks, and, also, the correction amount needs to be properly adjusted based on the luminance transmittance or the like of the display unit 59. In such a case, the feedback information may be automatically adjusted by using a detection result obtained by using a luminance transmittance detecting camera or the like that is prepared in advance, for example. The backlight luminance correcting unit 57 supplies video signals corrected by the above-noted processing or the like to the timing control unit 58.

The timing control unit 58 controls the timings at which the video signals supplied from the backlight luminance correcting unit 57 are displayed on the screen of the display unit 59 in the horizontal and vertical directions, thereby generating image information to be displayed on the screen of the display unit 59, followed by supplying the generated image to the display unit 59.

The timing control unit 58 ensures that the backlight unit 56 turns on the backlight of the backlight unit 56 in synchronization with the video images displayed on the screen. To this end, the timing control unit 58 supplies, to the backlight drive and control unit 55, timing control signals for turning on the backlight corresponding to given video signal at the same timing at which the video signal is supplied to the display unit 59.

With this arrangement, the video output of the display unit 59 and the backlight output of the backlight unit 56 corresponding to the video output are synchronized with each other.

The display unit 59 displays video information generated by the timing control unit 58 on the screen. An LCD panel or the like may be used as the display unit 59. This is not intended to be a limiting example.

With the above-noted arrangement, the present embodiment drives the backlight of the display unit 59 such as an LCD panel dynamically in conjunction with the video contents, thereby providing high-contrast video images.

Namely, the display apparatus 50 of the present embodiment can corrects the luminance of the backlight device in response to the video contents that are displayed on the display unit 59, thereby achieving optimum backlight control responsive to the video contents. Accordingly, luminance interference with the video signal that could occur with the dimming operations performed by the LCD backlight can be improved, resulting in increasingly optimum dimming operations.

In the present embodiment, optimum luminance control may be achieved based on the detection of a luminance histogram or the like in addition to the standard luminance control that is performed based on conventional APL detection. For example, LED backlight control for RGB may be performed based on optimum white balance control by use of a detected histogram. Namely, the present embodiment may perform backlight luminance control by only using various types of detected histograms, or may perform backlight luminance control by combining a detected APL result with the various types of detected histograms.

<Example of Other Applications of Backlight Device>

The backlight device described in the above-noted embodiments may be not only used in a display device such as a TV set, but also used in lighting apparatus, electronic billboards, other types of display devices, etc. That is, the backlight device of the present embodiment is widely applicable to any equipment that drives light emitting devices such as LEDs. In the following, examples of other applications of the backlight device will be described with reference to drawings.

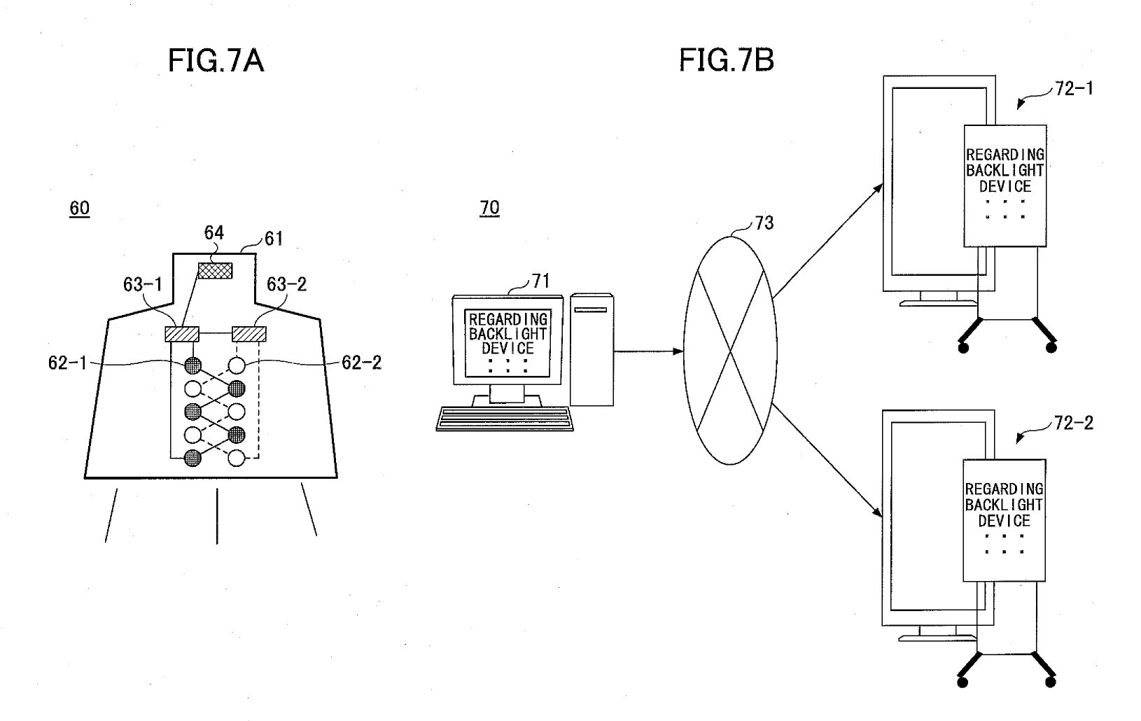

FIGS. 7A and 7B are drawings illustrating examples of other applications of the backlight device according to the present embodiment. FIG. 7A illustrates an example in which the backlight device is applied to a lighting apparatus according to the present embodiment, and FIG. 7B illustrates an example in which the backlight device is applied to an electronic billboard system according to the present embodiment.

A lighting apparatus 60 illustrated in FIG. 7A is an LED lamp, which is only an example. Specifically, the lighting apparatus 60 includes a predetermined number of LEDs 62-1 connected in series and a predetermined number of LEDs 62-2 connected in series, both of which are accommodated in a lamp cover 61. Each LED set is placed at a predetermined position suitable for the direction of illumination. Each LED set may be configured as a light emitting device block as described above.

The LEDs 62-1 and 62-2 each connected in series are connected to respective driver ICs (LED drive and control units) 63-1 and 63-2 as illustrated in FIG. 7A. The driver ICs 63-1 and 63-2 separately drive and control the LEDs 62-1 and 62-2, respectively. A control IC (main control unit) 64 generates control data for driving and controlling the LED sets, which are separately controlled by the driver ICs 63-1 and 63-2, respectively. The control IC 64 then generates control signals inclusive of drive control information that is obtained by combining the generated control data and address information or the like for identifying the driver ICs.

The driver ICs 63-1 and 63-2 are connected in series as illustrated in FIG. 7A. The control IC 64 transmits the above-described control signals through the driver IC 63-1 and the driver IC 63-2, so that each driver IC refers to the address information included in the control signals. When the included address information matches the address information assigned in advance to a given driver IC, this driver IC performs drive control by use of the control data. The number of driver ICs connected in series is not limited to the illustrated example, and may vary according to the size and shape of the lighting apparatus 60, for example.

An electronic billboard system 70 illustrated in FIG. 7B includes a PC 71 and a plurality of electronic billboards 72 (i.e., electronic billboards 72-1 and 72-2 in the example illustrated in FIG. 7B). The PC 71 and the electronic billboards 72 are connected together through a communication network 73 such as the Internet, thereby being able to exchange data with each other.

In the electronic billboard system 70 illustrated in FIG. 7B, contents for describing products or presenting company names created and edited by an administrator or the like using the PC 71 are simultaneously displayed and updated via the communication network 73 on the electronic billboards 72 placed at different locations. The electronic billboards 72 described above may be a large-size liquid crystal display or the like. The backlight device of the embodiments previously described may be applied to such a large-size liquid crystal display or the like.

In the electronic billboards 72 illustrated in FIG. 7B, driver ICs may be connected in series, and a control IC may send control signals to all the driver ICs as described above. With this arrangement, the electronic billboards 72 may properly drive and control the LEDs that are allocated to the respective driver ICs connected in series. The backlight device described above is also applicable to the liquid crystal display of the PC 71.

In the examples illustrated in FIGS. 7A and 7B, the light emitting devices connected in series are placed in an alternating arrangement of a predetermined number of light emitting devices in response to differences in variation information and/or colors that are set for each light emitting device.

Further, in the examples of other applications of the backlight device according to the present embodiment as illustrated in FIGS. 7A and 7B, the driver ICs may be connected in series to reduce the manufacturing cost and to improve tolerance to interference. Moreover, the control signals as previously described may be used to achieve proper drive control on a driver-IC-specific basis.

According to the technologies disclosed herein, provision is made to provide a backlight device, a display apparatus having such a backlight device, and a lighting apparatus for which uneven luminance in backlighting or lighting is prevented by supplying stable, uniform currents.

The backlight device of the disclosed technologies may be widely applicable to the display screen of a TV set or PC, a portable terminal, the display screen of a digital camera or the like provided with backlight, etc.

Further, the present invention is not limited to these embodiments, but various variations and modifications may be made without departing from the scope of the present invention.

The present application is based on Japanese priority application No. 2010-267418 filed on Nov. 30, 2010, with the Japanese Patent Office, the entire contents of which are hereby incorporated by reference.

What is claimed is:

1. A backlight device, comprising:
a plurality of light emitting devices arranged at predetermined positions to act as backlight for a display screen; and
a plurality of drive circuits that supply currents to the plurality of light emitting devices,
wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit,
and wherein the plurality of light emitting devices are spatially placed in an alternating arrangement of one or more of the first light emitting devices and one or more of the second light emitting devices.

2. The backlight device as claimed in claim 1, wherein the plurality of light emitting devices are spatially placed in an alternating arrangement of one or more of the first light emitting devices and one or more of the second light emitting devices in response to differences in at least one of variation information and color information set for each of the plurality of light emitting devices.

3. The backlight device as claimed in claim 1, wherein the plurality of light emitting devices are disposed at least one of top and bottom edges, left and right edges, and a back face of the display screen.

4. The backlight device as claimed in claim 1, wherein device blocks each including the plurality of light emitting devices or luminance blocks each including the device blocks are provided for the display screen, and one or more of the first light emitting devices and one or more of the second light emitting devices alternate with each other in each of the device blocks or in each of the luminance blocks.

5. A display apparatus, comprising:
a display unit;
a plurality of light emitting devices arranged at predetermined positions to act as backlight for a display screen of the display unit; and
a plurality of drive circuits that supply current to the plurality of light emitting devices,
wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit,
wherein the plurality of light emitting devices are spatially placed in an alternating arrangement of one or more of the first light emitting devices and one or more of the second light emitting devices, and luminance of the plurality of light emitting devices is corrected in response to video images displayed by the display unit.

6. The display apparatus as claimed in claim 5, further comprising:
a block information acquiring unit that divides video signals into blocks on a frame-by-frame basis, the video signals being input for display by the display unit; and
a block control unit that controls and corrects luminance of the backlight separately for each of the blocks generated by the block information acquiring unit,
wherein the backlight is controlled separately for each of the blocks with respect to the display unit based on luminance control information obtained by the block control unit.

7. The display apparatus as claimed in claim 6, comprising a backlight luminance correcting unit that corrects the video signals based on the luminance control information for the backlight, wherein video signals obtained by the backlight luminance correcting unit are displayed by the display unit.

8. A lighting apparatus, comprising:
a plurality of light emitting devices; and
a plurality of drive circuits that supply currents to the plurality of light emitting devices,
wherein the plurality of drive circuits include a first drive circuit and a second drive circuit, and the plurality of light emitting devices include a plurality of first light emitting devices and a plurality of second light emitting devices, the plurality of first light emitting devices being connected in series to the first drive circuit, and the plurality of second light emitting devices being connected in series to the second drive circuit,
and wherein the plurality of light emitting devices are spatially placed in an alternating arrangement of one or more of the first light emitting devices and one or more of the second light emitting devices.
